(19) United States
(12) Patent Application Publication
(10) Pub. No.: US 2026/0165351 A1
(43) Pub. Date: Jun. 18, 2026

(54) Sweetening Composition, Method of Preparation and Use of Composition from Seaweed

(71) Applicants: Lauro Bianchin, Umuarama, Paraná (BR); Edson Paiva Soares Junior, Ananindeua, Pará (BR)

(72) Inventor: Edson Paiva Soares Junior, Ananindeua, Pará (BR)

(21) Appl. No.: 18/711,913

(22) PCT Filed: Dec. 13, 2023
(86) PCT No.: PCT/BR2023/050452

§ 371 Date: May 21, 2024

(30) Foreign Application Priority Data
Sep. 19, 2023 (BR) 1020230190316

(51) Int. Cl. A23L 27/30; A23L 2/02; A23L 2/60; A23L 17/60

(52) U.S. Cl. CPC A23L 27/33; A23L 2/02; A23L 2/60; A23L 17/60

(57) ABSTRACT

This invention belongs to the field of foods or food products and preparations based on seaweed or seaweed derivatives, as well as other organic active ingredients, such as natural sweetening agents. The invention describes sugar obtained from seaweed using only four natural ingredients, trehalose, neohesperidin, lithothamnium, and spirulina. It has a sweet flavor, a sweetening power greater than that of common sugar, an alkaline pH and is a source of minerals such as iron, zinc, potassium and magnesium, without the addition of preservatives or pesticides. In addition, the method of production and its use in the preparation of a food product, beverage, nutritional product, dietary supplement, feed product, personal care product, pharmaceutical product or industrial product are described.

### FIELD OF THE INVENTION

This invention belongs to the field of foods or food products and preparations based on seaweed or seaweed derivatives, as well as other organic active ingredients, such as natural sweetening agents. The present invention refers to a sugar, a composition containing said sugar, the process of producing said composition, and its uses.

### BACKGROUND

Carbohydrates are considered the main source of energy for the human body. They are mostly found in food, contributing texture, appearance, aroma and flavor, especially sweetness. Furthermore, they allow different production technologies to be adopted as they are involved in important reactions in food, such as caramelization, the Maillard reaction, and numerous fermentation processes. Carbohydrates can be classified according to their structural complexity, involving size and molecular weight, as: monosaccharides, oligosaccharides (including disaccharides) and polysaccharides (LAJOLO; MERCADANTE, 2018; DAMODARAN; PARKIN, 2019).

Excessive food consumption, especially of high-calorie foods and meals containing high sugar and fat content, contributes to the increased prevalence of overweight and obesity. In genetically predisposed individuals, the high demand for insulin on the beta cells of the pancreas contributes to the gradual failure of these cells and may lead to glucose intolerance. Thus, consistently high blood glucose levels enable an increase in the risk of type II diabetes mellitus, a chronic non-communicable disease that is closely associated with overweight and obesity (SAWAY; LEANDRO; WAITZBER, 2018). Moreover, the excessive consumption of simple sugars enhances the production of triglycerides and the risk of cardiovascular diseases, being associated with obesity and contributing to the development of dental caries (MANHANI et al., 2014).

The search for food alternatives that can reduce the nutritional deficit by seeking new processes and raw materials is on the rise. Innovative studies involving biotechnology, using microorganisms or enzymes to produce new products, including foods, are mesmerizing modern society (MULITERNO et al., 2005). The acceptability of a microorganism, especially for use in human and animal feeding, depends on its nutritional value and safety, which includes a low content of nucleic acids, absence of toxins and undesirable residual compounds. (BEKATOROU; PSARIANOS; KOUTINAS, 2006).

Microalgae are microorganisms that contain photosynthetic pigments that can be classified into three groups: chlorophylls (especially chlorophyll A, the most important pigment for photosynthesis, as it plays a key role in the photosystem for the capture of light energy), carotenoids and phycobilins, these pigments differ in their chemical composition and ability to absorb light at a certain wavelength. These microorganisms are capable of performing oxygenic photosynthesis, have relatively simple nutritional requirements and are found across all ecosystems on Earth, not only aquatic but also terrestrial, encompassing a wide range of species that live in widely varying environmental conditions (ARREDONDO-VEGA, 1995; CHISTI, 2004; SHELEF; SOEDER, 1980).

Microalgae have been used in human diet since ancient times, most notably some species of the genus Nostoc, consumed in Asia, and Spirulina, in Mexico, which was habitually eaten by the Aztecs with cereals in the form of a sauce known as “chimolli” or Aztec sauce, and by the Kanembu people in Africa, where women harvested the spirulina in Lake Chad, when the winds pushed and agglomerated these microalgae on the banks, they would dry the biomass in the sun and, subsequently, knead it with their hands, shaping it into blocks and cutting them into small tablets (AARONSON; BERNER; DUBINSKY, 1980; CIFERRI; TIBONI, 1985; NAVALHO, 1998; NORTON; MELKONIAN; ANDERSEN, 1996).

### Spirulina

Spirulina (Arthrospira platensis or Arthrospira maxima), a member of the order Oscillatoriales, the genus Spirulina is a microscopic, photosynthetic, unicellular, filamentous, bluish-green cyanobacterium composed of spiral-shaped (which originated its name) trichomes that are 5-6 μm wide and 20-200 μm long, whose habitat is alkaline waters (HOFF; SNELL, 1999; SHIMAMATSU, 2004).

Within this genus, the most important species are: S. platensis, followed by S. maxima and S. fusiformis. The cell wall is enveloped by a capsule or sheath composed of polysaccharides and does not contain cellulose. For this reason, spirulina is 85-95% assimilated by the body (BABADZHANOV et al., 2004).

The nutritional importance of Spirulina is established by the range of nutrients that it contains, some of which are not synthesized by the human body. Due to this range, it becomes a complete food, and one can claim that spirulina is the food with the greatest number of different nutrients per unit of weight (PHANG et al., 2000). We can find proteins (60-70%), carbohydrates (20%), lipids (8%), as well as minerals, vitamins, pigments, phenolic compounds, gamma-linolenic acid and other essential fatty acids, in its composition (BELAY et al., 1993; VON DER WEID; DILLON; FALQUET, 2000).

The main minerals present in Spirulina are: calcium (0.13 to 0.14%), phosphorus (0.67 to 0.9%), and potassium (0.64 to 1.54%). The following are also present: magnesium, iron, zinc, copper, chrome, manganese, and sodium. The vitamins present in Spirulina are: vitamin A in the form of beta-carotene, vitamin C and group B vitamins (B1, B2, B3, B6, and B12), biotin, folic acid, inositol, vitamin E, and pantothenic acid. Among the pigments that make up Spirulina are phycocyanin (20%) and carotenoids (0.37%) (HENRIKSON, 1994; RICHMOND, 1990).

The benefits for health provided by the consumption of microalgae are being investigated and have been better recognized and appreciated over the last two decades, especially since the introduction of probiotic compounds (BARROW; SHAHIDI, 2008). Spirulina and its constituents have several nutritional and therapeutic properties that make it an excellent food supplement and a potential resource to be used for the prevention and treatment of numerous diseases, thus consisting of an efficient alternative for the development of nutraceutical products and characterizing the microorganism in the context of functional foods (AMBROSI et al., 2008).

The action of Spirulina was proven in in-vivo and in-vitro experimental research, which has observed the following: its protective effect on the induction of oxidative stress and cadmium hepatotoxicity in rats (AMIN et al., 2006); help with the removal of lead from wastewater (HONG; SHAN-SHAN, 2005); inhibition of the growth of Ehrlich Ascites Carcinoma Cells (EACC), by phycocyanin, acting as a chemosuppressive agent (ELBAKY, 2003); hypocholesterolemic action (NAGAOKA et al., 2005), antidiabetic property, increasing hexokinase activity and decreasing glucose-6-phosphatase activity (LAYAM; REDDY, 2006); maintenance of the balance of the immune system, in addition to increasing intestinal lactobacilli, reducing the nephrotoxicity caused by heavy metals and drugs (YANG; LEE; KIM, 1997); protection against ultraviolet radiation; antioxidant activity (BIERHALS et al., 2009; GUARIENTI; BERTOLIN; COSTA, 2010); and reduction of obesity by increasing the activity of lipoprotein lipase (LPL) and the effect of protein on satiety, which, due to the increased level of plasma amino acids observed after protein ingestion, stimulates the release of anorexigenic hormones and insulin, which will act on the satiety center, resulting in reduced appetite (BECKER et al., 1986; LANG et al., 1998; PAIVA; ALFENAS; BRESSAN, 2007).

Spirulina also stands out for its high content of cyanocobalamin (vitamin B12), which is difficult to find in vegetarian diets; for folic acid (vitamin B9), necessary for the formation of cells and a proper function of the cardiovascular and nervous systems; and for its supply of minerals (Zn, Mg, Cr, Se, Fe), which are necessary for the maintenance of metabolism, the conservation of skin and mucous membranes and the normal development of bones and teeth (BECKER, 1994; BROWN et al., 1999).

Furthermore, the use of the biomass of Spirulina platensis microalgae was approved in Brazil by the Ministry of Agriculture and Livestock (MAPA) as a raw material for animal feed, as a plant ingredient.

### Lithotamnium

In search of a compound that eliminates losses resulting from heat stress and at the same time promotes improvement in animal performance, research has also evaluated the use of the calcareous seaweed Lithothamnium calcareum, or popularly known as lithotamnium, which, due to its alkalizing characteristic, acts to maintain the acid-base balance, concomitantly providing minerals with very high bioavailability that are adsorbed to its cell wall and easily assimilated and absorbed by the body due to its honeycomb-like porous structure (MELO, 2006).

Lithothamnium calcareum belongs to the group of non-articulated red algae, in the phylum Rhodophyta, the order Corallinales and the family Coralineacea (GRAHAM & WILCOX, 2000). It grows at great depths in the marine environment where light is still present, its free form called rhodolite is widely distributed throughout the Brazilian continental shelf and thus is a source of minerals with potential for industrial exploitation (DIAS, 2000).

Souza (2012), when studying the application of Lithothamnium calcareum algae to the diet of chickens, found that at a level of inclusion of 1% of calcareous seaweed there was an improvement in the percentage of egg laying, as well as in the percentage of cracked eggs, eggshell thickness, number of pores and percentage of mineral matter and calcium in the eggshell. Using seaweed in a study conducted on quails, Melo (2006) observed an improvement in the quality of eggshells, although the author believes that more studies must be carried out to support this hypothesis. The calcareous seaweed Lithothamnium calcareum is a mineral source of organic (plant) origin rich in calcium and magnesium carbonate, its structure also contains more than 20 elements, such as iron, manganese, boron, nickel, copper, zinc, molybdenum, selenium, and strontium (DIAS, 2000).

Lithotamnium, or calcareous seaweed, as it is popularly known, was approved by the Ministry of Agriculture and Livestock for use as a raw material in animal feed, as a mineral ingredient.

### Trehalose

Trehalose is a highly soluble sugar, but it is chemically nonreactive due to its non-reducing nature, making it compatible with cell metabolism even at high concentrations. Trehalose is widely distributed across bacteria, fungi and invertebrates, which use it as an osmolyte and protector against stress, as well as for carbon storage and transport (ELBEIN, 1974; BENAROUDJ et al., 2001; BONINI et al., 2004).

In recent years, a new approach that consists of producing sugars from algae through photosynthesis has been developed. The accumulation of sugar can be increased under osmotic stress (osmoregulation). Bremauntz (2011) shows the production of sugars from algae, isolated from natural sources, and the effect of osmotic stress on the accumulation of fermentable sugars. Twelve strains of algae were isolated, showing growth between 0.6 and 1.8 g of dry biomass per liter, all producing intracellular and extracellular sugars from trehalose to sucrose. The Chlorella sp. strain showed a greater increase in sugar production, reaching 421 mg of sugars/g of dry biomass after 24 h of osmotic stress with 0.4 M NaCl. It was pointed out that both sucrose and trehalose provided osmotic potential for microalgae to survive in hypersaline environments (BREMAUNTZ et al., 2011).

Trehalose was subsequently found in green algae, mosses, liverworts, and ferns, but apart from a small number of desiccation-tolerant resurrected plants, there have been few reports of the presence of trehalose in angiosperms (ELBEIN, 1974; KANDLER E HOPF, 1980; DRENNAN et al., 1993; ITURRIAGA et al., 2000). The amounts of trehalose found in flowering plants were usually very low and were often suspected of having a fungal or microbial origin (KANDLER AND HOPF, 1980).

Trehalose is approved for use by the Ministry of Agriculture and Livestock as a raw material in animal feed, as a thickening additive.

### Neohesperidin

Neohesperidin or neohesperidin dihydrochalcone is a flavanone with important antioxidant properties obtained from oranges. Oranges contain the flavanone aglycones hesperitin and naringin, but they rarely occur as free aglycones in the fruit itself. The dominant glycosidic flavanones in sweet oranges (C. sinensis) are hesperidin and narirutin, while in sour oranges (C. aurantium) the two predominant glycosidic flavanones are neohesperidin and naringin. The main difference between the glycosidic flavanones in sweet oranges and sour oranges is in their sugar molecules, which influence their flavor. The sugar rutinose (6-O-a-rhamnosyl-p-D-glucose) gives the flavanones hesperidin and narirutin a neutral flavor and is relatively high in sweet oranges, tangerines and tangors. On the other hand, the sugar neohesperidose (2-O-a-L-rhamnosyl-p-D-glucose) is high in tangelos and sour oranges and imparts a bitter or pungent flavor to the glycosidic flavanones neohesperidin and naringin (PETERSON et al., 2006).

In studies by Takii et al. (1997), flavonoids acted as adjuvants in the treatment of DM-II, as the postprandial blood glucose peak in rats treated with neohesperidin fell by around 50% (TAKI et al., 1997). In a study with PC12 neurological cells, Hwang and Yen (2008) showed the ability of this flavonoid to preserve the viability of these cells against the oxidative stress promoted by H₂O₂. This flavonoid prevented damage to the cell membrane, showed the ability of ROS sequestration, and increased the activity of anti-oxidizing enzymes (HWANG; YEN, 2018).

Neohesperidin is approved for use by the Ministry of Agriculture and Livestock as a raw material in animal feed, as a sweetening additive.

### STATE OF THE ART

In patent BR 112015008569-5, the preparation of flour granules produced from the microalgae spirulina and chlorella, preferably, was taught. The steps include making an emulsion of microalgae flour in water, using a homogenizer, spraying the emulsion in a dryer, and, finally, collecting the flour granules.

Another relevant national patent document in this regard is BR112022004774-6, which belongs to Cargill, Inc. It discloses a composition based on seaweed and several foodstuffs. Red seaweed from the families Gigartinaceae, Bangiophyceae, Palmariaceae, Hypneaceae, Cystocloniaceae, Solieriaceae, Phyllophoraceae and Furcellariaceae or combinations thereof are used.

Patent U.S. Pat. No. 6,900,173 describes protein bars containing 200 to 2000 mg of different types of algae, including spirulina. The production of perioperative multivitamins is also taught. The function of the product is to provide a supplementary food capable of improving immunity, promoting the health of the intestinal microbiota to reduce the collateral damage of antibiotics in surgical patients.

In patent U.S. Pat. No. 10,448,661, a powdered food composition contains carbohydrates, proteins, lipids, probiotics, vitamins, minerals, and fiber. The function of the liquid mixture is to decrease the consumer's glycemic index. The sweetener used in the composition includes neospyridine dihydrochalcone from a natural source. Similarly, patent U.S. Pat. No. 11,045,401 makes use of sweeteners in the method of production of pharmaceutical compositions so as to reduce undesirable flavors for the consumer. Specifically, neohesperidin is applied in view of the fact that it is a sweetener with high sensory intensity.

The use of neohesperidin (NHDC) as a sweetener is disclosed in other documents, such as patents U.S. Pat. Nos. 11,266,170, 11,304,431, and 11,535,584, and patent US 2009/0311686, US 2015/0245642, US 2019/0239540 and US 2019/0364945, US 2020/0337339, US 2020/0367543, WO 2015/044880, WO 2015/134062, WO 2016/036980, WO 2023/049850.

Patent document JP2013013424 establishes a methodology to produce trehalose through the reduction of partial starch hydrolysates using a trehalose-releasing enzyme. This invention comprises a new trehalose-releasing enzyme, the methods of production thereof and a microorganism for producing it. Carbohydrates containing trehalose and trehalose obtained from the reduction of partial starch hydrolysates using a trehalose-releasing enzyme, a non-releasing saccharide-forming enzyme and a composition containing trehalose are described.

In patent document JP2005295829, methods for obtaining algae-based compositions are described. The composition comprises pigments, trehalose, glycerol and propylene glycol. These compositions have excellent thermal stability and are used for coloring food. A method of production thereof is also described.

Patent document CN109730250 describes an antioxidant food composition containing algal extract, prepared from green algae. The combination of algal extracts in medicinal beverages, with a final composition of chlorella extract and trehalose, is part of the knowledge of traditional Chinese medicine.

In publication EP 1,206,197, a dietary high-fiber food composition is taught. The spirulina extract is used together with other natural plant sources, such as the Morinda citrifolia plant. The product is intended to be consumed in the form of a juice by consumers interested in increasing the amount of fiber in their daily diets.

In patent document US 2020/0275682, a protein drink with a non-animal source composition that uses spirulina in its production is disclosed. The protein produced from spirulina showed good solubility, few undesirable flavors and good sensory acceptability.

Patent document DE102006056454 describes a nutritional food supplement in granular form that is capable of preventing osteoporosis and psoriasis. The composition includes seaweed, such as the microalgae spirulina and chlorella and the macroalgae lithotamnium. The compositions are synergistic, since each has its own unique effect. The product is intended to be consumed by an individual to prevent several bone diseases. The composition is preferably 56% spirulina, 25% chlorella and 15% lithotamnium, in addition to other ingredients in the formula.

Patent document DE102011112019 discloses a beverage containing up to 0.25 g/L of spirulina, lithotamnium and chlorella. The beverage is produced from the biomass of the algae spirulina and chlorella, mixed in water, heat treated for dispersion, and subjected to a process of separating and extracting the biomass by filtration to obtain a solution with 0.025% w/w of solids. Finally, lithothamnium extract and carbon dioxide are added for filling.

In this context, the object of this invention represents an innovation by providing pure sugar from seaweed, with physicochemical and nutritional characteristics that are completely different from ordinary sugar. The present invention departs from the state of the art due to the fact that it consists of seaweed sugar obtained from an unprecedented combination of four natural components, with enhanced synergistic action, being a functional food for diets and having an ionizing, alkalizing and mineralizing property.

### SUMMARY OF THE INVENTION

The present invention describes a sugar obtained from seaweed using only four natural ingredients: algal sugar, microalgae, macroalgae, and natural sweeteners. It has a sweet flavor similar to that of sugar and its sweetening power is greater than that of ordinary sugar. It has an alkaline pH and minerals such as iron, zinc, potassium and magnesium, being 100% natural and free of added preservatives and pesticides.

The invention proposes an algal sugar containing different components, preferably defined chemically as trehalose, or 1,1-a-trehalose (C12H22O11).

The inventive concept presented also comprises a sweetener composition from said algal sugar, mixed with macroalgae extract, microalgae extract and sweeteners.

The method of producing said composition is also disclosed by the steps of (a) mixing algal sugar with a sufficient amount of natural sweetener, (b) after completed, a sufficient amount of microalgae extract is added, then (c) a sufficient amount of macroalgae extract is added to the mixture and mixed until the end product is obtained.

The use of said sweetening composition for the manufacture of a food product, beverage, nutritional product, dietary supplement, feed product, personal care product, pharmaceutical product or industrial product is also disclosed herein.

### DETAILED DESCRIPTION OF THE INVENTION

Reference will now be made in detail to certain embodiments of the disclosed subject matter. Although the disclosed subject matter is described in conjunction with the claims listed, it will be understood that the illustrated subject matter is not intended to limit the claims to the disclosed subject matter.

The present invention refers to a composition called algal sugar comprising natural raw materials from plant sources with alkalizing, mineralizing and ionizing action. Its flavor is sweet, similar to sugar, and its sweetening power is higher than that of ordinary sugar, making it possible to replace 50 g of sugar with 1 g of “algal sugar”.

Particularly, algal sugar has sugars obtained from seaweed, such as trehalose, combined with microalgae extracts, such as spirulina, and a macroalgae extract, such as lithothamnium. Furthermore, a natural sweetener such as neohesperidin is employed to finish the product. The invention is based on the unprecedented identification of the sweetening capacity of the mixture, using plentiful and easily available raw material, by means of a low-cost method and on a large scale.

“Seaweed” means that different types of biological species are being mentioned, which can range from macroalgae from the plant kingdom, such as red algae (e.g.: Lithothamnium calcareum), to microalgae from the bacterial kingdom, such as cyanobacteria (blue algae, e.g.: Spirulina platensis).

On the other hand, the expression “microalgae” defines predominantly microscopic unicellular organisms, prokaryotes or eukaryotes, endowed with pigments and photoautotrophs selected from the genera Crypthecodinium, Haematococcus, Chlorella, Spirulina, Odontella, Ulkenia, among others.

Where “macroalgae” are mentioned, it means multicellular, eukaryotic living organisms, selected from chlorophytes (green algae), rhodophytes (red algae), and pheophytes (brown algae). Among the group of non-articulated red algae are the phylum Rhodophyta, the order Corallinales and the family Coralineacea, to which the species Lithothamnium calcareum belongs.

The definition of “raw material” means all matter in its natural state, that is, as observed in nature without processing or human intervention, with a specific functionality in the industry or market.

The term “marine algal sugar” means a sugar obtained from seaweed.

In addition, the term “marine algal sugar” refers to a blend-like mixture of components obtained from a natural source that is free of sucrose, maltose, fructose, lactose and glucose.

The term “marine algal sugar” also refers to a product that has an alkaline pH and minerals such as iron, zinc, potassium and magnesium, being natural and having no addition of preservatives and pesticides.

The expression “spirulina” refers to a minimally processed powder from microalgae or cyanobacteria of the species Arthrospira platensis, A. fusiformis or A. maxima.

For the purposes of the present invention, the term “lithothamnium” refers to the powdered extract of calcareous marine algae of the species Lithothamnium calcareum.

When “natural sweetener” is mentioned, it encompasses different types of chemical molecules from the group of polyphenolics, including glycosidic flavonoids.

“Glycosidic flavonoids” are important compounds with a sweetening activity, comprising the group called dihydrochalcones. Among the compounds that are mostly used as synthetic sweeteners are naringin dihydrochalcone and neohesperidin dihydrochalcone (or NDHC).

“Natural sweetener”, when mentioned, is any glycoside obtained from natural sources, most preferably a high-intensity sweetener such as neohesperidin, naringin, steviol glycosides, mogrosides, sucralose, neotame, and brazzein.

The term “extract” defines a minimally processed compound obtained by a physicochemical extraction process from natural raw material (unprocessed), selected from grinding, drying, crushing, pestling, among others.

The expression “mixing” mentioned here refers to the physical process of adding one or more ingredients into a container until a homogeneous powder is obtained. The mixing process is carried out in a mixer that was designed for this function. It has helical propellers and blades that mix in different directions, i.e. clockwise and counterclockwise. Knowing the time and amounts required is all that is necessary to understand the process.

On the other hand, the concept of “premix” identifies any intermediate step between the input of one or more raw materials until the end product is obtained.

The term “end product” establishes the composition with the calculated concentrations and the desired characteristics that were initially planned in the engineering project.

Particularly, the “end product” may also refer to a food product, beverage, nutritional product, dietary supplement, feed product, personal care product, pharmaceutical product or industrial product.

The “composition” described herein uses percentage by weight (% w/w) as a unit for quantities, unless otherwise indicated. The quantities can be simply measured on a previously calibrated analytical or semi-analytical gravimetric balance. For example, 5% w/w means that 5 grams of solute is contained in 100 grams of solvent.

Alternatively, in another embodiment of the invention, the “sweetening composition” will be named to indicate the use of the composition with the purpose of enhancing the sweet taste of foods that lack a sweet taste.

The “powdered” presentation described herein refers to a physical state in which the size of the particles that make up the whole is so small that they cannot be distinguished.

When the “method of production” is referred to herein, it includes the steps required to obtain a certain composition in a mill.

The “mixing time”, when informed, is of an exemplary nature and not precisely defined.

Unless defined otherwise, all technical and scientific terms used herein have the same meaning as understood by someone skilled in the art to which the present invention belongs. The specification also provides definitions of terms to help with the interpretation of what is described herein and the claims. The terminology used in the description of the invention is intended to describe preferred embodiments only, without any intention of limiting the scope of its teachings.

Unless otherwise indicated, the numerical parameters shown in the specification are approximations that may vary depending on the properties to be obtained.

In the methods described herein, the acts may be performed in any order without deviating from the principles of the invention, except when a temporal or operational sequence is expressly mentioned. Moreover, the specified acts can be performed simultaneously, unless the text of a claim explicitly states that they must be performed separately.

### Examples of Invention Embodiments

The examples below are represented in order to illustrate the best execution of the invention. It should be noted that the present invention is not limited to the examples mentioned and can be used in all the described applications or in any other equivalent variations.

The choice of the preferred embodiment of the present invention described in this detailed section is provided only as an example. Changes, modifications and variations can be made to any other embodiment of the enriched and enhanced fertilizer anchored in a granular core covered with algae and its production process, these changes can be designed by those skilled in the art without, however, deviating from the objective disclosed in the application of the present patent, which is exclusively defined by the attached claims.

### Example 1. Production of a Dry Powder

The marine algal sugar production process was performed using four dry ingredients that were minimally processed to a powdered state. The mixing process is carried out in a mixer that was designed for this function. It has helical propellers and blades that mix in different directions, i.e. clockwise and counterclockwise. Initially, trehalose and neohesperidin powder are added, at a ratio of 1:6 (neohesperidin:trehalose) by weight. After twenty minutes, it is added at a ratio of at least 1:7 (spirulina:premix) in the form of powder to the marine algal sugar premix. After another ten minutes of mixing, lithothamnium is added at a ratio of at least 1:9 (lithotamnium:premix) and mixed for another fifteen minutes. The doses used in this specific experiment are described below in Chart 1.

CHART 1
Composition for producing marine algal sugar.

| | | | Final |
|---|---|---|---|
| Component | Description | Presentation | Amount |
| Trehalose | Trehalose is a highly soluble sugar obtained from seaweed. | Powder | 65% |
| (A) | | | |
| Neohesperidin | Neohesperidin is a flavanone with antioxidizing properties | Powder | 10% |
| (B) | and an intensive sweet flavor. | | |
| Spirulina | Spirulina is a microscopic bluish-green cyanobacterium rich | Powder | 10% |
| (C) | in proteins, carbohydrates, lipids and minerals | | |
| Lithotamnium | Lithotamnium belongs to the group of red algae and has | Powder | 15% |
| (D) | mineralizing, ionizing and alkalizing properties. | | |
| | | | Total = 100% |

### Example 2. Sensory Characteristics—Flavor and Taste

Subjective methods were used to assess the sensory characteristics of the marine algal sugar. This method considered the opinions of individuals when interpreting the effects of sensory stimuli, whether simple or multiple, in accordance with the impressions perceived by the sensory organs (vision, smell, taste, touch and hearing). The form defined for the sensory attributes was described as components related to the properties of sugars, such as appearance, flavor, and taste.

Appearance refers to visible properties such as look, color, transparency, brightness, opacity, shape, size, consistency, thickness, degree of effervescence or carbonation and surface characteristics. Color, a property capable of causing retinal stimulation by beams of light with varying wavelengths, has its perception limited to the light source and must be assessed with suitable lighting such as, for example, daylight, either natural or artificial. During assessment, special cabins with visual color control were used. It was also defined with greater coherence and uniformity by means of color charts, discs, or color dictionaries. When assessing appearance and color, a chart with usual and common expressions was used to help the evaluator with the best descriptor.

Flavor and taste are considered as a mixed but unitary experience of olfactory, gustatory and tactile sensations perceived during tasting. Flavor is perceived mainly through the senses of taste and smell and is also influenced by tactile, thermal, painful and/or kinesthetic effects. To assess flavor and taste, consumers ingested a pre-established sample quantity in order to avoid excesses and proceeded to swallow it. Care was taken so as to avoid sensory fatigue, and the oral cavity was washed with filtered water between one sample and another.

For the tests described below, a concentrated Maguary passion fruit juice diluted at the ratio of 100 mL of concentrated juice in 900 mL of cold mineral water (10-15° C.) was used as a carrier. To sweeten 1,000 mL of the diluted passion fruit juice, 50 g of União refined sugar (Control) and 1.25 g of marine algal sugar (Sample) were used.

The algal sugar sample was evaluated in comparison with the Control sample for differences in general flavor, sweetness and sweet aftertaste by a team of 17 evaluators selected for their sensory acuity, the assessment was duplicated to obtain 34 answers.

The assessments were carried out in individual cabins equipped with the Compusense Cloud computerized system using a red light to mask possible color differences. The samples were randomly coded with three-digit numbers, and the product was served at a temperature between 1° and 15° C. in disposable cups with a capacity of 80 mL in accordance with an experimental design of balanced complete blocks. Each evaluator received, in addition to the Control identified as such (C), two coded samples, one at a time, with the Control also being presented with a code between the samples. The data obtained were subjected to an analysis of variance and Dunnett's test at a 1% error level to compare means.

The passion fruit juice samples sweetened with refined sugar and marine algal sugar were sensorially analyzed by 61 fruit juice consumers who did not refuse the passion fruit juice and were recruited from ITAL employees, students and interns. The test was conducted in individual cabins equipped with the Compusense Cloud computerized system for data collection and analysis, using a white light. The samples were presented in disposable plastic cups identified by random three-digit codes in accordance with an experimental design of balanced complete blocks. To clean the palate, natural mineral water was offered to be used at the beginning of the test and between samples.

The samples were assessed for:

Acceptability of appearance, aroma, general flavor, aftertaste and overall perception using a nine-point hedonic scale: 9=I liked it a lot, 5=I neither liked nor disliked it, and 1=I disliked it a lot; and

Passion fruit flavor intensity, sweetness, acidity, bitterness and full-bodiness using an ideal 5-point scale: 5=much stronger/sweeter/more acidic/more bitter/more full-bodied than I like, 3=just the way I like it, 1=much weaker/less sweet/less acidic/less bitter/waterier than I like.

The preference test was conducted after the assessment of the two samples, where the consumers were asked to mark the sample they preferred and describe the reasons for their preference.

The data relating to the attributes evaluated using a hedonic scale were subjected to an analysis of variance and Tukey's test to compare means. Using the XLSTAT 2022 statistical program, a Penalty Analysis was conducted, in which the effects of passion fruit flavor intensities, sweetness, acidity, bitterness and full-bodiness on overall acceptability were assessed.

When evaluating preference, the minimum number of concordant judgments required to establish a significant difference at various levels of probability for the Pairwise Comparison Test was defined by using a table.

In addition to questions related to product evaluation, the consumers answered questions about personal characteristics relating to age group, definition of social class according to the Brazilian 2022 economic classification criteria (ABEP, 2022) and fruit juice consumption habits.

The passion fruit juice sweetened with marine algal sugar at a proportion of 0.125% significantly differed at the error level of 1% from the juice sweetened with refined sugar, as described below. The “marine algal sugar” sample-presented a general flavor with a mean corresponding to “moderately different from the Control” and was considered moderately sweeter and having a sweet aftertaste between slightly and moderately more intense than the Control. The mean values obtained in the sensory evaluation of the marine algal sugar sample are shown in Table 1.

TABLE 1
Mean values obtained in the assessment of the algal sugar sample at
different concentrations in comparison with the “Control”.

| | General | | Sweet |
|---|---|---|---|
| Sample | flavor | Sweetness | aftertaste |
| Control - Refined sugar | 1.2 (0.4) a | 4.9 (0.4) a | 4.9 (0.5) a |
| Marine algal sugar - 0.125% | 2.8 (0.9) b | 6.8 (1.0) b | 6.6 (1.3) b |
| MSD (1%) | 0.39 | 0.45 | 0.56 |

Mean results for 34 answers. Values are expressed as mean (standard deviation). Means followed by a different letter from the coded Control differ statistically from the Control at the error level of 1%. MSD (1%): minimum significant difference from Dunnett's test at the error level of 1%.

### Example 3. Sensory Characteristics—Acceptability Test

Table 2 presents the average acceptability results for appearance, aroma, general flavor, aftertaste, and overall perception. In assessing appearance, general flavor and overall perception, the passion fruit juice sweetened with algal sugar presented averages close to “I like it” and differed significantly from the passion fruit juice sweetened with refined sugar, which presented averages close to “I like it a little” for these attributes.

The passion fruit juice sweetened with algal sugar was preferred by 42 consumers who participated in the test while the juice sweetened with refined sugar was preferred by 19 consumers.

For a total of 61 consumers, 40 answers are necessary for a given sample to be significantly preferred over the other at an error level of 5%. Therefore, it can be concluded that the juice sweetened with algal sugar was significantly preferred over the sugar-sweetened juice at the error level of 5%.

When the passion fruit juice sweetened with algal sugar was compared with the juice sweetened with refined sugar by the team of selected evaluators for sensory acuity (moderately different/sweeter general flavor and sweetness and sweet aftertaste between slightly and moderately more intense), this was positively reflected in the consumer's evaluation of the general flavor and overall perception. The consumers did not perceive any difference between the samples as for the aftertaste. It can also be noted that all evaluations resulted in a greater preference for the passion fruit juice sweetened with algal sugar, also illustrated by consumers' comments.

TABLE 2
Results obtained from the evaluation of the acceptability of the passion
fruit juice sweetened with refined sugar and with algal sugar

Passion fruit sweetened with

| | Refined | Algal | P |
|---|---|---|---|
| Acceptability | sugar | sugar | value |
| Appearance | 6.4 (1.6) b | 6.9 (1.5) a | 0.0013 |
| Aroma | 7.0 (1.5) a | 7.0 (1.5) a | 1.0000 |
| General flavor | 5.9 (1.7) b | 6.7 (1.3) a | 0.0001 |
| Aftertaste | 6.3 (1.6) a | 6.1 (1.6) a | 0.2540 |
| Overall perception | 5.9 (1.9) b | 6.5 (1.3) a | 0.0101 |

The results are expressed as the mean (standard deviation) of 61 evaluations. For each attribute, the means followed by different letters differ significantly from each other at a 5% error level using Tukey's test (p≤0.05)

As for aroma, both samples had means corresponding to “I like it”, and in relation to the aftertaste, these samples showed means corresponding to “I like it a little”, and there was no significant difference between the two attributes. The results are shown in Chart 2.

CHART 2
Sensory characteristics of sugar

| Characteristics | Specification | Methodology | Reference |
|---|---|---|---|
| Appearance (aspect | Light green | Visual | Instituto Adolfo |
| and color) | crystal | | Lutz, 2018 |
| Flavor | Sweet | Pairwise | ISO 5492 |
| | | comparison | |

### Example 4. pH Determination

The processes assessing pH are colorimetric or electrometric. The former ones use indicators that produce or change their color at certain concentrations of hydrogen ions. The application of these processes is limited, since measures are approximate and do not apply to intensively colored or turbid solutions or to colloidal solutions that may absorb the indicator and lead to false results. Electrometric processes employ devices that are especially adapted potentiometers, allowing the direct, simple and accurate determination of pH.

10 g of the seaweed sugar sample was weighed in a beaker and diluted with 100 mL of water. The content was stirred until the particles, if any, were evenly suspended. The pH was then determined using the previously calibrated device, which was operated according to the instructions in the manufacturer's manual. pH values are shown in Table 3.

### Example 5. Determining Moisture by Ambient Pressure Drying

This method is applicable to several types of sugars, including rapadura. It is based on the determination of mass loss through drying under specified temperature and time conditions. 10 g of the fully homogenized sample was weighed in a flat-bottom capsule with a lid, whose tare weight had been previously measured. Then they were dried in an oven for 2 hours at (105 ±2° C.) and the capsule was removed from the oven, covered, cooled in a desiccator and weighed. The drying operations were repeated for 30 minutes, and cooling was repeated until the weight between two drying processes had a difference of less than or equal to 2 mg. The values are shown in Table 3.

$$\begin{matrix}Humidity calculation ( \% ) & \\ \frac{N \times 100}{P} = humidity percent rn / m & Equation 1\end{matrix}$$

$$N = mass loss ( g ) ;$$

$$P = sample mass ( g ) .$$

TABLE 3
Physicochemical characteristics

| Characteristics | Specification | Methodology | Reference |
|---|---|---|---|
| pH | 9.55 | MA-CQ. 135, | Instituto Adolfo |
| | | method 017 | Lutz, 1985 |
| Humidity | 0.45 | AOAC Official | AOAC |
| | | Method 925.45 B | International |
| | | | Organization, [symbol] |

[symbol]

indicates data missing or illegible when filed

### Example 6. Nutritional information

The total protein content of the dry biomass was determined by the Kjeldhal method (BRASIL. Ministério da Saúde. Agência Nacional de Vigilância Sanitária. Métodos físico-químicos para análise de alimentos. 4th ed. Brasília: Ministério da Saúde, 2005. 1018p. (Series A-Standards and Technical manuals)), using factor 6.25 to convert total nitrogen into protein, for whey samples the conversion factor used was 6.38. Protein contents are shown in Table 3.

Total lipids were determined by the Soxhlet method according to the AOAC (ASSOCIATION OF OFFICIAL ANALYTICAL CHEMISTS INTERNATIONAL.

Official methods of analysis of the Association of Official Analytical Chemists. 17.ed. Gaithersburg: AOAC, 2000. v.2).

The carbohydrate index was determined by the Luff Schoorl method according to the method proposed by Matissek et al. (MATISSEK, R.; SCHENEPEL, F. M.; STEINER, G. Analisis de los Alimentos: Fundamentos, metodos, aplicaciones. Espana: Acribia S. A, 1998. 416p). As attested by the technical reports issued by the Institute of Food Technology (ITAL), it is free of sucrose, maltose, fructose and glucose, and also has zero calories.

Minerals were assessed using ashes according to the protocol of the USDA (USDA-United States Department of Agriculture. Release 2010. Available at: www.nal.usda.gov/fnic/foodcomp/cgi-bin/list nut edit.pl). Values are shown in Table 4-Nutritional information.

TABLE 4
Nutritional information

| Amount per portion | 100 g | % DV (*) | 5 g | % DV (*) |
|---|---|---|---|---|
| Energy value (kcal) | 339 | 17 | 17 | 1 |
| Carbohydrates (g) | 84.16 | 28 | 4.21 | 1 |
| Proteins (mg) | 0.2 | 1 | 0.03 | 0 |
| Calcium (mg) | 2070 | 207 | 104 | 10 |
| Iron (mg) | 4.46 | 32 | 0.22 | 2 |
| Phosphorus (mg) | 12 | 2 | 0.6 | 0 |
| Magnesium (mg) | 206 | 49 | 10.3 | 2 |
| Manganese (mg) | 0.15 | 0 | 0.008 | 0 |
| Potassium (mg) | 14 | 5 | 0.7 | 0 |
| Sodium (mg) | 27 | 0 | 1.4 | 0 |
| Zinc (mg) | 0.031 | 0 | 0.002 | 0 |
| Copper (mg) | 0.020 | 2 | 0.001 | 0 |

(*) Daily values based on a diet of 2,000 kcal. Daily values may be higher or lower depending on the person's calorie needs.

1. SWEETENING COMPOSITION characterized in that it comprises 65% to 80% by weight of seaweed sugar, preferably trehalose powder obtained from seaweed; 10 to 50% by weight of microalgae extract, preferably spirulina powder extract; 10 to 15% by weight of macroalgae extract, preferably lithotamnium powder extract; and at least one natural sweetener at 5 to 10% by weight.

2. (canceled)

3. (canceled)

4. (canceled)

5. (canceled)

6. COMPOSITION, according to claim 1, characterized in that a natural sweetener is chosen from a group of high-intensity natural sweeteners, such as neohesperidin, naringin, steviol glycosides, mogrosides, and brazzein.

7. COMPOSITION, according to claim 2, characterized in that the natural sweetener is preferably neohesperidin.

8. COMPOSITION, according to claim 1, characterized in that it comprises more preferably 65% by weight of trehalose, 10% by weight of spirulina, 15% by weight of lithothamnium, and 10% by weight of neohesperidin.

9. METHOD OF PRODUCTION for obtaining the composition as defined in any one of claims 1 to 5, characterized in that it comprises the steps of:
(a) mixing sugar from seaweed, specifically trehalose powder obtained from seaweed, and natural sweetener; sweetener,
(b) adding microalgae extract to the product, specifically spirulina extract powder
(c) adding macroalgae extract to the mixture, specifically lithotamnium extract powder; and
(d) mixing until the end product is obtained.

10. (canceled)

11. (canceled)

12. (canceled)

13. (canceled)

14. (canceled)

15. (canceled)

16. METHOD, according to claim 6, characterized in that steps a), b) and c) last 20, 10 and 15 minutes, respectively.

17. USE of a composition as defined in any one of claims 1 to 5 characterized in that it is intended for manufacturing a food product, beverage, nutritional product, dietary supplement, feed product, personal care product or pharmaceutical product.

18. COMPOSITION, according to claim 1, characterized in that the amount of seaweed sugar is between 6 and 8 times by weight the amount of the microalgae extract and the natural sweetener, and 5 to 6 times the amount of the microalgae extract by weight.
